(19) United States
(12) Patent Application Publication
(10) Pub. No.: US 2009/0037840 A1
(43) Pub. Date: Feb. 5, 2009

(54) Location Determination For Z-Direction Increments While Viewing Medical Images

(75) Inventor: Yuanhsi (Tony) Chen, Mt. Laurel, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/024,371

(22) Filed: Feb. 1, 2008

Related U.S. Application Data
(60) Provisional application No. 60/953,791, filed on Aug. 3, 2007.

(51) Int. Cl. G06F 3/048

(52) U.S. Cl. 715/784

(57) ABSTRACT

An apparatus and method for controlling a scrolling speed of an apparatus for selecting an image, having steps of providing the image on a viewing device;

dividing the viewing device into a plurality of regions, and assigning an incremental value to each of the plurality of regions, wherein the incremental value is used to calculate the scrolling speed of the apparatus.

### CROSS-REFERENCE TO RELATED APPLICATIONS

The present application seeks priority to U.S. Provisional Application 60/953,791, filed Aug. 3, 2007, the entirety of which is incorporated by reference herein.

### FIELD

Aspects of the present invention relate to viewing of medical images. More specifically, aspects of the present invention relate to providing interaction control of a pointing device, such as a mouse, during viewing of the medical images.

### BACKGROUND INFORMATION

When controlling viewing functions during review of medical images, such as in a workflow for a picture archiving system (PACs), the ability to control the “z” direction increment (scrolling speed) while performing diagnostic functions is important. Researchers who use such systems must accurately review the images contained within the system to accurately diagnose a patient. Unfortunately, conventional systems do not provide the needed ability to quickly and accurately allow a researcher to scroll images with sufficiently fine detail to enable fine image control with a minimum of lost time for the individual using the system.

The embedded risk of such movement without proper increment control might result in skipping a critical area (i.e. an area that may contain a tumor) of the diagnosis target especially when such critical area contains only few image pixels (or voxels).

One alternative to provide motion control capability is to increment the control one pixel (or voxel) at a time. This alternative, however, is not practical as the resulting control is not practical and would be time consuming.

There is a need to provide for accurate control of pointing devices to be used for functions, such as zooming and/or z-direction scrolling, of medical images displayed.

There is a further need to provide for control of pointing devices such that the such control is intuitive and easily changed by the individual using the device.

There is a still further need to provide for a method of controlling pointing devices that may be used with conventional display devices, thereby giving these conventional devices added abilities of control previously unattainable.

There is also a need to provide for accurate zoom control and/or z-direction scrolling for a PACs device such that images of interest are not missed by researchers during investigational functions.

### SUMMARY

It is therefore an objective of an aspect of the present invention to provide for accurate control of pointing devices to be used for functions, such as zooming and/or z-direction scrolling, of medical images displayed.

It is also an objective of an aspect of the present invention to provide for control of pointing devices such that the such control is intuitive and easily changed by the individual using the device.

It is also an objective of an aspect of the present invention to provide for a method of controlling the pointing devices that may be used with conventional display devices, thereby giving these conventional devices added abilities of control previously unattainable.

It is a further objective of an aspect of the present invention to provide for accurate zoom control and/or z-direction scrolling for a PACs device such that images of interest are not missed by researchers during investigational functions.

The objectives of the aspects of the invention are achieved as illustrated and described. In an exemplary embodiment, a method of controlling a scrolling speed of an apparatus for selecting an image is provided, the method comprising providing the image on a viewing device;

dividing the viewing device into a plurality of regions, and assigning an incremental value to each of the plurality of regions, wherein the incremental value is used to calculate the scrolling speed of the apparatus. In another exemplary embodiment, the incremental value comprises at least one pixel increment value.

In another exemplary embodiment, the method may be performed, wherein the apparatus comprises at least one of a joystick, mouse, roller ball, touch screen and a directional key for navigating.

In another exemplary embodiment, the method may be performed such that the images reviewed are volumetric images. The incremental value may also be user selectable.

In another exemplary embodiment, the method may be performed such that the plurality of regions are rectangular regions, oval or circular regions.

In another exemplary embodiment, the method may be performed such that a scrolling speed is indicated to the user based upon the current incremental value.

In another exemplary embodiment, a program storage device is providing machine, tangibly embodying a program of instructions executable by the machine to perform method steps for controlling a scrolling speed of an apparatus for selecting an image, comprising: providing the image on a viewing device, dividing the viewing device into a plurality of regions, and

assigning an incremental value to each of the plurality of regions, wherein the incremental value is used to calculate the scrolling speed of the apparatus. In another exemplary embodiment, the incremental value comprises at least one pixel increment value.

In another exemplary embodiment, the program storage device is configured such that method that is performed such that the apparatus comprises at least one of a joystick, mouse, roller ball, touch screen and a directional key for navigating.

In another exemplary embodiment, the program storage device is configured such that the method performed volumetric images to be reviewed. The incremental value may also be user selectable.

In another exemplary embodiment, the program storage device is configured to perform the method such that the plurality of regions are rectangular regions, oval or circular regions.

In another exemplary embodiment, the program storage device is configured such that the method is performed so that a scrolling speed is indicated to the user based upon the current incremental value.

### BRIEF DESCRIPTION OF THE DRAWINGS

FIG. 1 is a diagram of a rectangular strip pattern used to determine increment speed to an area of interest for a pointing device, in accordance with an exemplary embodiment of the invention.

FIG. 2 is a diagram of a circular pattern used to determine incremental speed for the pointing device.

FIG. 3 is a flowchart for a method for controlling a speed for a pointing device.

### DETAILED DESCRIPTION

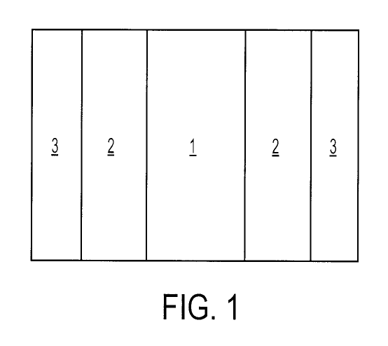

Referring to FIG. 1, a rectangular strip pattern for determining incremental speed of a pointing device is presented. The pointing device, such as a mouse, is used to control viewing functions of images on an image replication device. In the present invention, the image replication device may be a computer configured to allow viewing of images on a monitor, such as a Picture Archive System (PACs).

In an exemplary embodiment provided, a viewing area is divided into multiple regions, wherein each region is assigned an intended increment. The interactive control of increment (speed) is based on which region the mouse pointed is located. In the illustrated embodiment, the rectangular strip pattern is divided into Region 1, Region 2 and Region 3. The increment in “z-direction” is under the control by the image reader. As an exemplary embodiment, the control parameters represented in Region 1 have a one pixel increment of speed movement, while strip areas marked as Region 2 are defined with a 2 pixel increment of speed movement. Strip areas marked as Region 3 are defined with a 5 pixel increment of speed movement. The strip areas provided and the speed movement for each area is merely exemplary. More or less movement may be chosen.

The pattern illustrated in FIG. 1 divides the viewing area into vertical strips, for example, and assigns each strip with a desired increment. With such concept definition, an image reader can perform 1 pixel increment of z-direction scrolling capability to avoid skipping information during scrolling, or perform multi-pixel increment movement for faster interaction speed without interrupt the workflow to setup the increment. In other words, the actual incremental speed is totally controlled by image reader. There is no defined limit of the number of regions in the invention, and therefore the shapes provided in FIG. 1 are merely exemplary.

As provided in FIG. 1, the whole rectangular area represents the image viewing area such as whole or a portion of a computer screen. Each strip area defines a desired increment. For example, the strip area 1 defines one pixel as desired increment. Strip areas marked 2 define 2 pixels as desired increment. Strip areas marked 3 define 5 pixels as the desired increment.

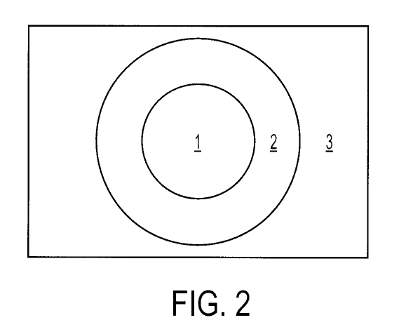

Referring to FIG. 2, a circular pattern of a viewing screen is presented that is used to determine increment speed for a pointing device. Similar to FIG. 1, three area patterns are provided for control of incremental speed. In the exemplary embodiment circular area 1 defines one pixel as the desired speed increment for scrolling. Circular area marked 2 defines 2 pixels of speed movement for scrolling. Circular area marked 3 defines 5 pixels as the desired increment for speed movement for scrolling.

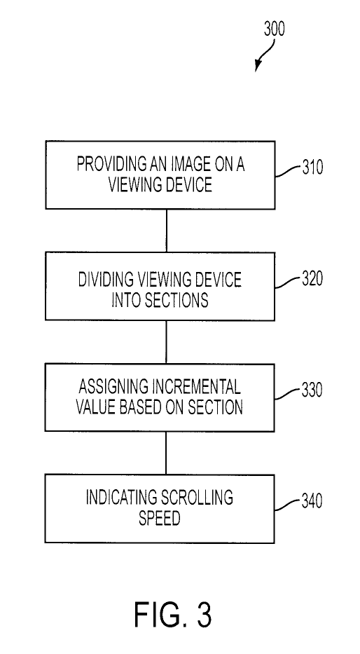

Referring to FIG. 3, a method 300 for controlling a speed of a pointing device is provided. In the method 300 provided, the image is displayed on a viewing device 310. The image may be a visual image obtained by a scanning device, such as a CT scanning device, an X-ray or other similar device. Next, the viewing device is divided into a plurality of regions 320. The division may be any such division that would be helpful to the individual using the system. The system may also provide for selection of the division type, thereby allowing the individual to specify the type and/or speed factor assigned to each division. Next, an incremental value is assigned to each of the plurality of regions 330, wherein the incremental value is used to calculate the scrolling speed of the apparatus.

An algorithm may also be employed for controlling the speed of the pointing device based upon the use of the user. In using the algorithm, a computer memory may be used to identify previous action of the user and allow the function of the scrolling of the device to learn the specific patterns of the user, thereby allowing the user to have a more customized interface.

Although being described as applicable to mouse pointing driven cursors, the methods described may also be used for a variety of devices used to track move cursors, not limited to trackball devices, joysticks, arrow directional keys and touch screens.

An embodiment of the invention may also be used in conjunction with three dimensional models, wherein the speed adjustment performed is for zooming in/out of the model presented on the visual representation. The researcher may then navigate within the model based upon cursor position. Zooming functions may also be used in two dimensional scans, as applicable.

An embodiment of the invention may also be used with coronal multiplanar reformatted/reconstructed (MPR) images from computed tomographic (CT) data scans.

An embodiment of the present invention provides for accurate control of pointing devices to be used for functions, such as zooming and scrolling, of medical images displayed.

An embodiment of the present invention also provides for control of pointing devices such that the such control is intuitive and easily changed by the individual using the device.

An embodiment of the present invention further provides for a method of controlling the pointing devices that may be used with conventional display devices, thereby giving these conventional devices added abilities of control previously unattainable.

An embodiment of the present invention also provides for accurate zoom control for a PACs device such that images of interest are not missed by researchers during investigational functions. The present invention may also be used in conjunction with devices, such as, computer aided drafting machines (CAD) or personal computers.

In the foregoing specification, the disclosure has been described with reference to specific exemplary embodiments thereof. It will, however, be evident that various modifications and changes may be made thereunto without departing from the broader spirit and scope of the disclosure as set forth in the appended claims. The specification and drawings are accordingly to be regarded in an illustrative rather than in a restrictive sense.

What is claimed is:

1. A method of controlling a scrolling speed of an apparatus for selecting an image, comprising:
providing the image on a viewing device;
dividing the viewing device into a plurality of regions; and
assigning an incremental value to each of the plurality of regions, wherein the incremental value is used to calculate the scrolling speed of the apparatus.

2. The method according to claim 1, wherein the incremental value comprises at least one pixel increment value.

3. The method according to claim 1, wherein the apparatus comprises at least one of a joystick, mouse, roller ball, touch screen and a directional key for navigating.

4. The method according to claim 1, wherein the image is a volumetric image.

5. The method according to claim 1, wherein the incremental value is user selectable.

6. The method according to claim 1, wherein the plurality of regions are rectangular regions.

7. The method according to claim 1, wherein the plurality of regions are oval in shape.

8. The method according to claim 1, wherein the plurality of regions are circular in shape.

9. The method according to claim 1, further comprising:
indicating a scrolling speed to the user based upon the current incremental value.

10. A program storage device readable by machine, tangibly embodying a program of instructions executable by the machine to perform method steps for controlling a scrolling speed of an apparatus for selecting an image, comprising:
providing the image on a viewing device;
dividing the viewing device into a plurality of regions; and
assigning an incremental value to each of the plurality of regions, wherein the incremental value is used to calculate the scrolling speed of the apparatus.

11. The program storage device according to claim 10, wherein the incremental value comprises at least one pixel increment value.

12. The program storage device according to claim 10, wherein the apparatus comprises at least one of a joystick, mouse, roller ball, touch screen and a directional key for navigating.

13. The program storage device according to claim 10, wherein the image is a volumetric image.

14. The program storage device according to claim 10, wherein the incremental value is user selectable.

15. The program storage device according to claim 10, wherein the plurality of regions are rectangular regions.

16. The program storage device according to claim 10, wherein the plurality of regions are oval in shape.

17. The program storage device according to claim 10, wherein the plurality of regions are circular in shape.

18. The program storage device according to claim 10, further comprising:
indicating a scrolling speed to the user based upon the current incremental value.
